(19) United States
(12) Patent Application Publication
(10) Pub. No.: US 2013/0321123 A1
(43) Pub. Date: Dec. 5, 2013

(54) SYSTEM AND METHOD FOR CONTROLLING ELECTRICAL APPLIANCES

(71) Applicant: Wah Tong Thomas Wan, Singapore (SG)

(72) Inventor: Wah Tong Thomas Wan, Singapore (SG)

(73) Assignee: ACTATEK PTE. LTD., Singapore (SG)

(21) Appl. No.: 13/984,304

(22) PCT Filed: Feb. 9, 2011
(86) PCT No.: PCT/SG2011/000058

§ 371 Date: Aug. 8, 2013

(51) Int. Cl. G07C 9/00

(52) U.S. Cl. CPC G07C 9/00
USPC 340/5.2

(57) ABSTRACT

A system for controlling electrical appliances is disclosed. The system comprises: at least one detection device configured to acquire detection data, indicating the presence or absence of a user in a spatial region; a comparison unit configured to (i) receive the acquired detection data from the at least one detection device; (ii) access a database storing data associating each of a list of users with respective stored detection data and a respective set of electrical appliances; (iii) compare the acquired detection data against the stored detection data in the database; and (iv) if the acquired detection data matches the stored detection data of one of the list of users in the database, identify the user associated with the matched stored detection data and extract the set of electrical appliances associated with the identified user; and a control device configured to control the extracted set of electrical appliances associated with the identified user based on predefined settings.

### FIELD OF THE INVENTION

The present invention relates to a system and method for controlling electrical appliances. The present invention may be used for controlling electrical appliances in a secure area and may be combined with a lock device for regulating access to the secure area.

### BACKGROUND OF THE INVENTION

A more efficient energy usage or decreased energy consumption from conventional energy sources can help achieve energy conservation. This is important in view of the energy crisis in recent years.

Power consumption in residential and commercial buildings makes up a large percentage of the world's power consumption. For example, tube lights, bulbs, fans, television sets, air-conditioners and many other electrical appliances in homes require a non-negligible amount of energy. The same applies for the electrical appliances at several workplaces. When there are a large number of electrical appliances in a home or at a workplace, manually turning off the electrical appliances one at a time is tedious and time-consuming. Very often, the user will leave the home or the workplace without turning off at least one (sometimes, even all) of the electrical appliances. This results in energy wastage.

Lighting control systems using motion sensors to detect occupancy have been implemented. These systems are usually configured to turn off the lighting in a particular area if the motion sensors do not detect motion after a certain period of time. When a person enters the area, the motion sensors detect his or her presence and this triggers the lighting control system to turn on the lighting. In such lighting control systems, there tends to be a time lag between the time a person enters the area and the switching on of the lighting. Furthermore, it is necessary to ensure that the sensors are placed at locations whereby there is no blockage between the sensors and the people entering the area. Also, in cases whereby the motion sensors are not sufficiently sensitive, slight movements of the occupant may not be detected and the lighting control system may be triggered to turn off the lighting even when the occupant is still in the area. On the other hand, if the motion sensors are over-sensitive, the lighting may be switched on even in the absence of occupancy.

Power control systems using artificial neural networks (ANN) have also been implemented [Carlos Machado and José A. Mendes, Automatic Light Control in Domotics using Artificial Neural Networks, International Journal of Computer Systems Science and Engineering 4:2 2009]. In these systems, the users' normal power usage patterns are determined and are then used to predict the state that the electrical appliances should be in at a certain time. This predicted state is then used to turn on or off the electrical appliances. However, such systems would not work if a user's power usage does not follow a fixed pattern.

### SUMMARY OF THE INVENTION

The present invention relates to a novel and useful system and method for controlling electrical appliances.

In general terms, the present invention proposes controlling electrical appliances by having different sets of electrical appliances whereby each set of electrical appliances is controlled using predefined settings upon acquiring detection data from a user associated with the set of electrical appliances.

Specifically, a first aspect of the present invention is a system for controlling electrical appliances, the system comprising: at least one detection device configured to acquire detection data, indicating the presence or absence of a user in a spatial region; a comparison unit configured to (i) receive the acquired detection data from the at least one detection device; (ii) access a database storing data associating each of a list of users with respective stored detection data and a respective set of electrical appliances; (iii) compare the acquired detection data against the stored detection data in the database; and (iv) if the acquired detection data matches the stored detection data of one of the list of users in the database, identify the user associated with the matched stored detection data and extract the set of electrical appliances associated with the identified user; and a control device configured to control the extracted set of electrical appliances associated with the identified user based on predefined settings.

A second aspect of the present invention is a method for controlling electrical appliances, the method comprising: acquiring detection data, indicating the presence or absence of a user in a spatial region; accessing a database storing data associating each of a list of users with respective stored detection data and a respective set of electrical appliances; comparing the acquired detection data against the stored detection data in the database; if the acquired detection, data matches the stored detection data of one of the list of users in the database, identifying the user associated with the matched stored detection data and extracting the set of electrical appliances associated with the identified user; and controlling the extracted set of electrical appliances associated with the identified user based on predefined settings.

### BRIEF DESCRIPTION OF THE FIGURES

An embodiment of the invention will now be illustrated for the sake of example only with reference to the following drawings, in which:

FIG. 1, illustrates a system for controlling electrical appliances according to an embodiment of the present invention; and

FIG. 2 illustrates example databases employed by the system of FIG. 1.

### DETAILED DESCRIPTION OF THE EMBODIMENTS

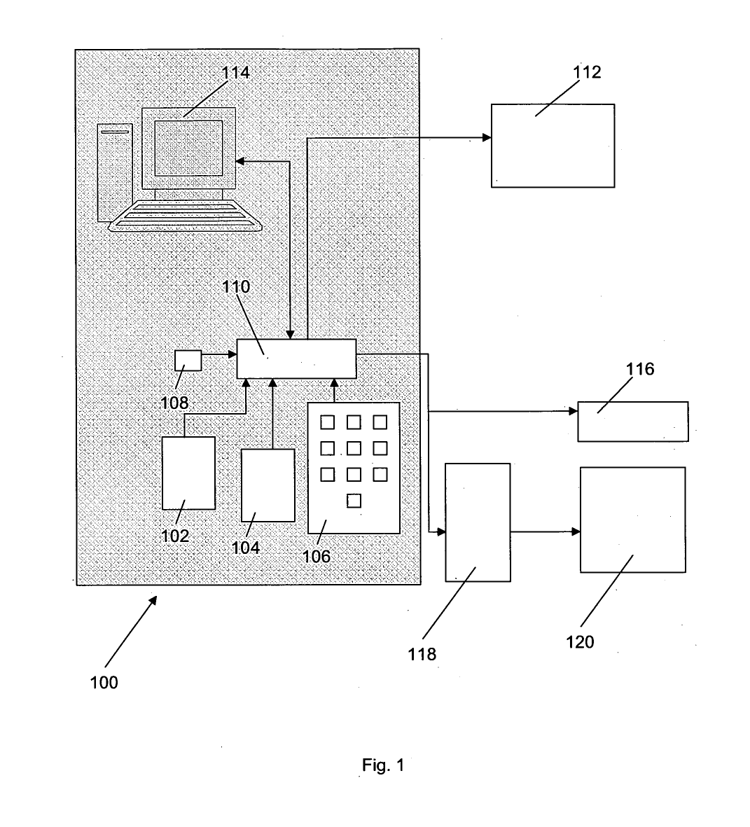

Referring to FIG. 1, a system 100 according to an embodiment of the present invention is illustrated. The system 100 comprises a plurality of detection devices 102, 104, 106, 108 and a control device 110. The system 100 also optionally comprises a computing device 114 and the control device 110 may be configured to communicate with the computing device 114 via a two-way communication link.

The system 100 serves to control electrical appliances 112 based on predefined user settings. For example, the system 100 may control the electrical appliances 112 by turning on or off these electrical appliances 112. Alternatively, the system 100 may simply turn up or down the electrical appliances 112 without turning them on or off. The system 100 may also log on or off these electrical appliances 112 or log the electrical appliances 112 on or off a network or a database. Note that in this document, “electrical appliances” include any electrical appliances, electronic appliances, computer appliances, IT appliances or any other appliances requiring an electrical supply (including that from a battery). The electrical appliances 112 may also comprise security devices. The system 100 may optionally be linked with a display device 116 and a lock device 118 which may in turn be linked to a door 120.

The components of the system 100 will now be described in more detail.

The plurality of detection devices comprises a biometric sensor 102, a card reader 104 (which may be a RFID smart card reader, a contact smart card reader, a magnetic card reader or a bar-coded card reader), a keypad 106 and a camera 108 (which may be a still camera for capturing still images or a video camera for capturing motion pictures or for detecting motion). At least one of these detection devices 102, 104, 106, 108 is configured to acquire detection data from a user and is further configured to transmit the detection data it acquires, to the control device 110. The presence of detection data indicates that a user is interacting with the system 100. In other words, it indicates the presence or absence of a user in a spatial region.

Depending on the type of detection device, the acquired detection data may be in different forms. For example, the biometric sensor 102 is configured to acquire detection data in the form of biometric data from the user. The biometric sensor 102 may be a finger- or hand-print, or vein- or sub veinous, iris or facial or any other form of biometric sensor. The card reader 104 is configured to cooperate with a user's card (which may be a RFID smart card, a contact smart card, a magnetic card or a bar-coded card) to detect the interaction between the user and the system 100. In particular, it is configured to acquire detection data in the form of the card identity of the user's card. The keypad 106 is configured to register key-presses by a user and may have any number of keys, for example 10 keys corresponding to the digits 0 to 9 or a full QUERTY keyboard. With the keypad 106, the user may enter a password (which may comprise alphanumeric characters) unique to the user. In other words, the keypad 106 is configured to acquire detection data in the form of passwords. The camera 108 is configured to acquire detection data in the form of one or more still images or motion pictures of a user as the user interacts with the system 100. The camera 108 may also be configured to detect motion of the user.

The control device 110 alone, the computing device 114 alone (if present) or both the control device 110 and the computing device 114 may serve as a comparison unit which employs a database storing data associating each of a list of users with respective stored detection data and a respective set of electrical appliances 112. Each set of electrical appliances 112 in the, database may comprise a single electrical appliance 112, a plurality of electrical appliances 112 or in some cases, may be a null set comprising no electrical appliance 112.

Upon receiving the acquired detection data, the control device 110 may process the acquired detection data or forward the acquired detection data to the computing device 114 (depending on whether the comparison unit comprises the control device 110 alone, the computing device 114 alone or both the control device 110 and the computing device 114). In either case, the comparison unit receives the acquired detection data. The comparison unit is further configured to access the database and compare the acquired detection data against the stored detection data in the database. If the acquired detection data matches the stored detection data of one of the list of users in the database, the user associated with the matched stored detection data is identified and the set of electrical appliances associated with this identified user is extracted.

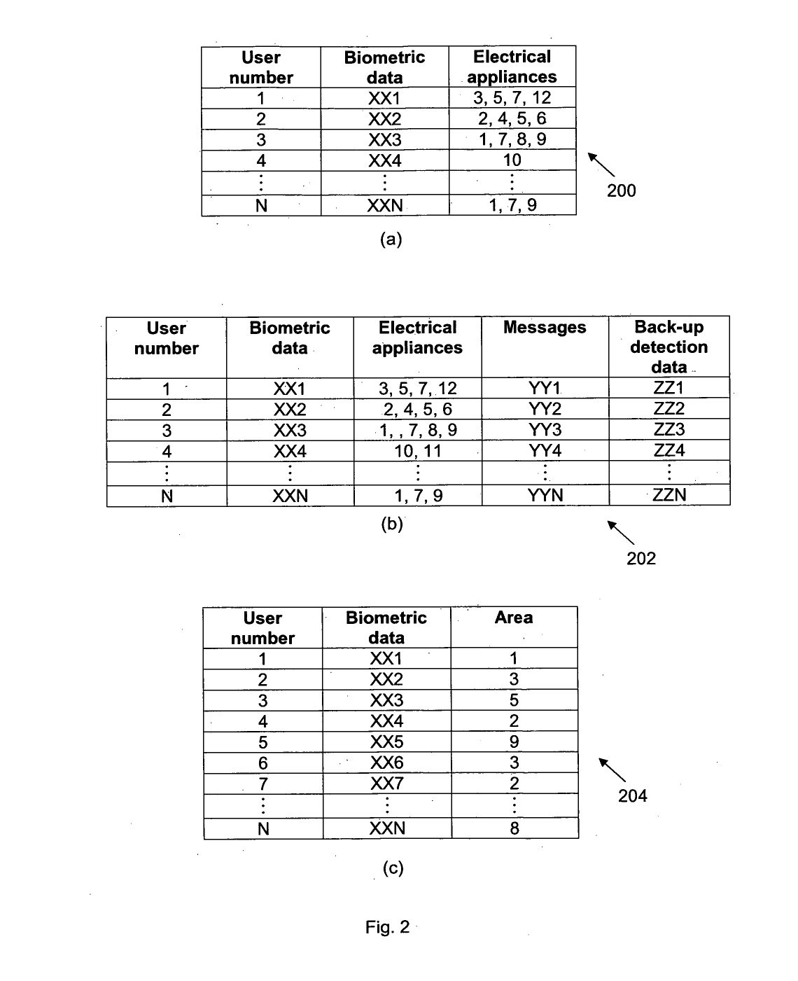

FIGS. 2(a)-(c) illustrate example databases that may be employed by the comparison unit.

FIG. 2(a) illustrates a first example database 200. In the first example database 200, each electrical appliance 112 is given a label in the form of a number. Alternatively, a different form of label may be used. As shown in FIG. 2(a), the first example database 200 stores data associating each user 1-N with a set of electrical appliances 112. Furthermore, for each user 1-N, the first example database 200 stores corresponding biometric data (shown as XX1-XXN) unique to the user. Note that the stored biometric data in the first example database 200 may be replaced by other forms of detection data. For example, the database may instead store strings of alphanumeric characters forming passwords unique to each user.

An example of how the comparison unit employs the first example database 200 is illustrated as follows. Upon receiving acquired biometric data from the biometric sensor 102, the comparison unit accesses the first example database 200 and compares the acquired biometric data with the stored biometric data in the “Biometric data” field of the first example database 200. If the acquired biometric data matches the stored biometric data of one of the users (1-N) in the first example database 200, the comparison unit identifies the user associated with this matched stored biometric data and extracts the electrical appliances associated with this identified user.

FIG. 2(b) illustrates a second example database 202 which the comparison unit may employ. The second example database 202 is similar to the first example database 200 except that it comprises two extra data fields “Messages” and “Back-up detection data”. However, note that the database may instead comprise only one of these extra data fields i.e. either “Messages” or “Back-up detection data” field.

The “Messages” data field in the second example database 202 stores messages associated with the users. Each message may be unique to a user and may be configured by the user himself or herself. Furthermore, the message may be a simple welcome or goodbye message, a reminder message (for example, reminding a home owner of the things that need to be replenished at home or reminding an employee of his/her schedule for the next day etc.). The message may also be an advertising message targeted at the user. In addition, the message may be in the form of visual and/or audio information. If as shown in FIG. 1, the system 100 is linked with a display device 116 (note that this is optional), upon the comparison unit identifying a user, a message associated with the user may be displayed on the display device 116. Note that the term “display” is used in this document to include the case of generating sound only. Furthermore, the display device 116 may only be operative to display a visual message, generate only sound or display a visual message and at the same time, generate sound.

The “Back-up detection data” field in the second example database 202 stores other forms of detection data besides biometric data. These other forms of detection data may comprise one or more of the following: passwords comprising a string of alphanumeric characters, identities of cards, still images and motion pictures of the list of users. In one example, these other forms of detection data are used to identify the user interacting with the system 100 only when biometric identification fails. Alternatively, these other forms of detection data may be used in combination with the biometric data to improve the accuracy of the user identification. For example, after the user has submitted his/her biometric data to system 100 via the biometric sensor 102, the user may be prompted to present his/her card to the card reader 104 (which then acquires the user's card identity) and may also be prompted to enter a password via the keypad 106. At the same time, one or more still images (or motion pictures) of the user may be acquired by the camera 108. The acquired card identity, password and image(s) or motion picture(s) of the user are then compared against the stored data in the “Back-up detection data” field of the second example database 202 whereas the acquired biometric data is compared against the stored data in the “Biometric data” field of the second example database 202. If a match is present (i.e. all of the biometric data, card identity, password and image(s) or motion picture(s) of the user match the respective stored data in the database 202), the user associated with the matched stored data is identified and his/her associated electrical devices are extracted. Of course, it is sufficient if the database stores just one or two other forms of detection data. Note also that the “Biometric data” field in the second example database 202 may be replaced by a field comprising other forms of detection data and the “Back-up detection data” may be changed accordingly.

FIG. 2(c) illustrates a third example database 204 which the comparison unit may employ. This third example database 204 is similar to the first example database 200 except that in this example, instead of numbering the electrical appliances 112, the premise in which the electrical appliances 112 lie is divided into different areas and each area is given a number (similarly, a different form of label may be used for differentiating the areas from one another). In other words, the stored data in the third example database 204 comprises a list of areas in the premise. These areas may comprise for example, the different cubicles and rooms of a workplace (which are often designated to different users), different floors of a building and/or different rooms of a home etc. As shown in FIG. 2(c), each area is associated with a user.

An example of how the third example database 204 is employed is illustrated below. Upon receiving acquired biometric data from the biometric sensor 102, the control device 110 compares the acquired biometric data with the stored biometric data in the third example database 204 and if the acquired biometric data matches the stored biometric data of one of the users in the database, the user associated with this matched stored biometric data is identified. The comparison unit then selects the area associated with the identified user and extracts the set of electrical appliances 112 comprised in this selected area. This extracted set of electrical appliances 112 can be said to be associated with the identified user since it is comprised in the area associated with the identified user. Similarly, the stored biometric data in the third example database 204 may be replaced by other forms of detection data. Also, the comparison unit may employ a database similar to the third example database 204 but further comprising one or both of the additional data fields “Messages” and “Back-up detection data” in the second example database 202.

As mentioned above, the comparison unit may comprise only the control device 110 and in this case, the database may be stored at the control device 110. Alternatively, the comparison unit may comprise only the computing device 114 and the database may be stored at the computing device 114. In this alternative, after receiving the acquired detection data from the at least one detection device 102, 104, 106, 108, the control device 110 may be arranged to send the acquired detection data to the computing device 114. In a further alternative, the comparison unit comprises both the control device 110 and the computing device 114. In this further alternative, the control device 110 and computing device 114 can be said to be a single distributed comparison unit. Note that the control device 110 and the computing device 114 may be in the form of a computer or a mobile phone (e.g. iphone) etc and may employ web-based software via any web-browser to perform the required operations. The control device 110 and the computing device 114 may also be in the form of different components of a single computer system or a single mobile phone (e.g. iphone) system etc. Furthermore, the database may be stored on a separate server accessible by the control device 110 and/or the computing device 114 instead of at these devices 110, 114 themselves.

In one example, the comparison unit comprises both the control device 110 and the computing device 114, and the database is stored at the computing device 114 with at least a part of the database duplicated at the control device 110. The part of the database duplicated at the control device 110 may not be as comprehensive as the database stored at the computing device 114. For example, the list of users in this duplicated part of the database may comprise only a few regular users of the system 100. In this example, if the control device 110 is unable to find a match between the acquired detection data and the stored detection data in its database, the acquired detection data is sent to the computing device 114 for a more comprehensive comparison. If the computing device 114 detects a match, it then informs the control device 110.

In another example, the entire database is stored at both the computing device 114 and the control device 110, and the control device 110 uses a different comparison algorithm from the one used by the computing device 114. For example, the comparison algorithm used by the control device 110 may perform a rough search for a match between the acquired detection data and the stored detection data in the database whereas the computing device 114 may perform a finer search. Similarly, in this example, if the control device 110 is unable to find a match between the acquired detection data and the stored detection data in the database, the acquired detection data is sent to the computing device 114. Note that different comparison algorithms may also be used when the database stored at the computing device 114 differs from the database stored at the control device 110.

In yet another example, the comparison unit comprises both the control device 110 and the computing device 114, and the database is divided into two parts, a first part stored at the control device 110 and a second part stored at the computing device 114 (there may be overlaps between the first and second parts of the database). For example, the second example database 202 may be divided into two parts with the fields “User number”, “Biometric data” and “Back-up detection data” stored at the computing device 114 and the fields “User number”, “Electrical appliances” and “Messages” stored at the control device 110. In this example, upon receiving the acquired detection data, the control device 110 forwards the acquired detection data to the computing device 114. The computing device 114 then compares the acquired detection data against the stored detection data in the second part of the database 202 (in particular, using the “Biometric data” field and the “Back-up detection data” field) and identifies the user. The computing device 114 then informs the control device 110 of the identified user. The control device 110 then extracts the message and the set of electrical appliances 112 associated with the identified user using the first part of the database 202.

By implementing the single distributed comparison unit comprising both the control device 110 and the computing device 114, the computational load may be distributed between these two devices 110, 114. Thus, the complexity of the control device 110 may be reduced and the speed of the comparison may be improved.

The control device 110 is further configured to control the extracted set of electrical appliances associated with the identified user based on predefined settings.

The predefined settings may be comprised in a program and the program may be stored at the comparison unit. Furthermore, the program may comprise a comparison algorithm and the comparison unit may be configured to run the program upon receiving the acquired detection data. In one example, the running of the program performs the comparison (i.e. the step of comparing the acquired detection data against the stored detection data in the database), identification (i.e. the step of identifying the user associated with the matched stored detection data) and extraction (i.e. the step of extracting the identified user's associated set of electrical appliances 112) steps as mentioned above. The running of the program further generates control parameters for the extracted set of electrical appliances 112 based on the predefined settings. The control device 110 is further configured to control the electrical appliances using these control parameters.

As mentioned above, the comparison unit may comprise only the control device 110. In this case, the program and database are both stored at the control device 110 and the control device 110 is configured to run the program to generate the control parameters. Alternatively, the comparison unit may comprise only the computing device 114, and the program and database are both stored at the computing device 114. In this alternative, after receiving the acquired detection data from the at least one detection device 102, 104, 106, 108, the control device 110 may be arranged to send the acquired detection data to the computing device 114. The computing device 114 then runs the program and informs the control device 110 of the control parameters. These control parameters are then used by the control device 110 for controlling the electrical appliances 112.

In yet another alternative, the comparison unit comprises both the control device 110 and the computing device 114. In this alternative, the program may be divided into two portions with a first portion stored and run at the computing device 114 and a second portion stored and run at the control device 110. This division may be based on the division of the database between the control device 110 and the computing device 114.

For example, as mentioned above, the second example database 204 shown in FIG. 2(b) may be divided into two parts with the fields “User number”, “Biometric data” and “Back-up detection data” stored at the computing device 114 and the fields “User number”, “Electrical appliances” and “Messages” stored at the control device 110. In this case, the computing device 114 is configured to receive the acquired detection data from the control device 110, and perform the comparison and identification steps by running a first portion of the program. The computing device 114 is further configured to inform the control device 110 of the identified user, and the control device 110 is configured to use this information as input to a second portion of the program. Running the second portion of the program by the control device 110 then extracts the message and the set of electrical appliances 112 associated with the identified user. It also generates the control parameters for the extracted set of electrical appliances 112. The control device 110 is further configured to use these control parameters to control the electrical appliances 112.

In another example, the first portion of the program stored at the computing device 114 may perform the comparison, identification and extraction steps whereas the second portion of the program stored at the control device 110 may simply generate the control parameters for controlling the electrical appliances 112 based on predefined settings. In this example, the control device 110 is configured to send the acquired detection data to the computing device 114 whereas the computing device 114 is configured to send information relating to the extracted set, of electrical appliances to the control device 110. Information relating to the identified user may also be sent from the computing device 114 to the control device 110.

The electrical appliances 112 may be controlled in several ways. For example, the control device 110 may be configured to turn on or off at least one electrical appliance 112 in the extracted set of electrical appliances 112. The control device 110 may also be configured to turn up or down at least one electrical appliance 112 in the extracted set of electrical appliances 112 (for example, turn up or down the speed of a fan or a heater/air-conditioner). The control device 110 may be further configured to log on or off at least one electrical appliance 112 in the extracted set of electrical appliances 112 or to log at least one electrical appliance 112 in the extracted set of electrical appliances 112 on or off a network or a database.

Furthermore, the control device 110 need not control all the electrical appliances 112 in the extracted set of electrical appliances 112 in the same way. For example, user 1 in the first example database 200 shown in FIG. 2(a) may wish to turn on only electrical appliances 5 and 12, and leave electrical appliances 3 and 7 off after interacting with the system 100. Such user's preferences may be incorporated in the predefined settings. These settings will in turn determine the control parameters generated and hence, determine the way the electrical appliances 3, 5, 7, 12 are controlled.

In one example, the electrical appliances 112 comprise a computer and a script is stored at the computer. When the control device 110 sends a signal to the computer instructing it to power down, the script is run at the computer to ensure that the computer powers down in a particular sequence so as to minimize damage to the computer. Alternatively, the script may be stored at the control device 110. In this alternative, the script is loaded into (and run at) the computer whenever the computer is to be powered down.

It may also be possible to introduce a predefined time lag between acquiring the detection data from the user, and implementing the actions to control the user's associated set of electrical appliances 112 (these actions may be for example, changing the state of the user's associated set of electrical appliances 112). In this case, the system 100 may be configured such that if it receives detection data from the same user within the predefined time lag, the actions are not implemented. This predefined time lag may vary at different times of the day. Such a predefined time lag prevents unnecessary switching of the state of the electrical appliances 112 especially when a user leaves a certain area for only a short while or when the user accidentally presents detection data to the system 100. Similarly, such a predefined time lag may be incorporated in the predefined settings which will in turn determine the control parameters generated.

As shown in the first, second and third example databases 200, 202, 204 in FIGS. 2(a)-2(c), it may be possible for two or more users to share a particular electrical appliance 112 (for example, electrical appliance 5 in the first example database 200). In this case, the control device 110 may be configured to implement the actions to control the electrical appliance 5 (for example, turning it on/off) only after it receives biometric data from all the users associated with this electrical appliance 5. Alternatively, the control device 110 may be configured to turn up/down the electrical appliance 5 every time it receives biometric data from a user associated with the electrical appliance 5. Similarly; this may be incorporated in the predefined settings which will in turn determine the control parameters generated.

As shown in FIG. 1, the system 100 may be linked with a lock device 118 which serves to regulate access to a secure area (note that this is optional). This forms an integrated system. The lock device 118 may in turn be linked with a door 120 which serves as a security barrier against entry into the secure area. The control device 110 may be further configured to control the lock device 118 based on the comparison between the acquired detection data and the stored detection data in the database. In one example, all the users listed in the database are authorized users and if the acquired detection data matches the stored detection data of any one of these users, the control device 110 instructs the lock device 118 to unlock the door 120. Such an integrated system is useful as when a user interacts with the system 100 to unlock the door 120, this usually indicates that the user is entering (or leaving) the secure area and the electrical appliances associated with the user in this area should be turned on (or off) or up (or down).

In some embodiments, there may be two sets of detection devices 102, 104, 106, 108 (for example, one on each side of the door 120) whereby both sets of detection devices 102, 104, 106, 108 are configured to send acquired detection data to the control device 110. Note that each set of detection devices may comprise only one detection device. In this case, the comparison unit may be configured to determine from which set of detection devices the acquired data is received and the control device 110 may be configured to control the extracted set of electrical appliances based on this determination. For example, if the detection data is acquired and sent by the set of detection devices 102, 104, 106, 108 on the side of the door 120 not comprised in the secure area, this may mean that the user is entering the secure area and the electrical appliances should be turned on or up (if they are not already). The reverse applies if the detection data is acquired and sent by the set of detection devices 102, 104, 106, 108 on the side of the door 120 comprised in the secure area.

In one example, the system 100 is used at a workplace and the door 120 serves as a security barrier against entry into the workplace. In this example, when an employee (i.e. the user) interacts with the system 100 to unlock the door 120, it usually indicates that the employee is either entering or leaving the workplace, and the system 100 controls the set of electrical appliances associated with the employee accordingly. Further means may be used to determine if the employee is entering or leaving the workplace (for example, by using two sets of detection devices 102, 104, 106, 168 as mentioned above). Therefore, after a hard day at work, the employee need not make the extra effort to ensure that his/her electrical appliances are switched off as these electrical appliances may be turned off automatically using the system 100. Similarly, as the employee enters the workplace, the electrical appliances may be turned on automatically or in some cases, the employee may be automatically logged onto a computer, network, database or security device. This increases the level of convenience and efficiency for the employee at the workplace.

In another example, the system 100 is used in a home. Similarly, when the home owner(s) interacts with the system 100 to unlock the door 120, it usually indicates that the home owner(s) is either entering or leaving the home, and the system 100 controls the home electrical appliances accordingly. Further means may also be used to determine whether the home owner(s) is entering or leaving the home (for example, by using two sets of detection devices 102, 104, 106, 108 as mentioned above).

In yet another example, the electrical appliances 112 comprise a television set which comprises a relay circuit. This relay circuit is arranged with a power supply circuit to regulate the power supply to the television set. A switch signal may be sent to the relay circuit to turn on and off the relay circuit and this in turn turns on and off the power supply to the television set. In this example, the control device 110 is configured to send a switch signal to the relay circuit when a user associated with the television set interacts with the system 100. This turns on (or cuts off) the relay circuit which in turn turns on (or cuts off) the supply of power to the television set.

The system 100 may be employed together with motion sensors or light sensors to control the electrical appliances 112. For example, light tubes or lamps in a room of a secure area may be turned off after the user associated with these electrical appliances has left the secure area. Motion sensors may be placed beside these light tubes or lamps such that they are able to detect the presence of someone entering the room. Upon this detection, the light tubes or lamps may be turned on. Similarly, light sensors may be used to determine the amount of light entering a particular room at a certain time of the day and if sufficient light is detected, the lighting in the room may be turned off even if the user is still in the room. This helps to conserve energy. Note that in this case, when the user leaves the secure area, the lighting in the room is maintained in the off state since this is the desired state of the lighting when the system 100 detects that the user is leaving (and not entering) the secure area.

The system 100 is able to automatically control electrical appliances associated with a particular user. This removes the need for each user to manually turn on or off his or her electrical appliances. This also minimizes energy wastage as the set of electrical appliances associated with one user can be automatically turned off (without relying on the user's memory) while the remaining electrical appliances associated with other users can remain on. In addition, the system 100 allows automatic log-on to computers, networks, databases or security devices associated with a user once it acquires detection data from the user. This increases the efficiency and convenience at a workplace or in a home.

Further variations are possible within the scope of the invention as will be clear to a skilled reader.

For example, although a plurality of detection devices 102, 104, 106, 108 is shown in FIG. 1, a single detection device is sufficient for the system 100. Alternatively, a subset (i.e. not all) of the detection devices 102, 104, 106, 108 shown in FIG. 1 may be configured to cooperate with each other for acquiring the detection data from the user. In another alternative, more detection devices may be incorporated into the system 100. For example, the system 100 may comprise both a still camera for capturing still images of the user and a video camera for capturing motion pictures of the user.

Furthermore, the system 100 may comprise more computing devices so as to further distribute the computational load between these computing devices and the control device 110. The system 100 may also comprise more control devices 110 for controlling the electrical appliances 112. Also, the system 100 may be linked with more than one lock device 118 and more than one display device 116.

1. A system for controlling electrical appliances, the system comprising:
at least one detection device configured to acquire detection data, indicating the presence or absence of a user in a spatial region;
a comparison unit configured to
(i) receive the acquired detection data from the at least one detection device;
(ii) access a database storing data associating each of a list of users with respective stored detection data and a respective set of electrical appliances, said sets of electrical appliances including a said set consisting of a plurality of electrical appliances;
(iii) compare the acquired detection data against the stored detection data in the database; and
(iv) if the acquired detection data matches the stored detection data of one of the list of users in the database, identify the user associated with the matched stored detection data and extract the set of electrical appliances associated with the identified user; and
a control device configured to control the extracted set of electrical appliances associated with the identified user based on predefined settings;
wherein for any of said users from whom the associated set of electrical appliances comprises a plurality of electrical appliances, the control device is configured to control the plurality of electrical devices upon identifying the associated user.

2. A system according to claim 1, wherein the at least one detection device comprises a biometric sensor, and the acquired detection data and the stored detection data in the database are biometric data.

3. A system according to claim 1, wherein the at least one detection device comprises one or more of the following: a biometric sensor, a card reader, a keypad and a camera.

4. A system according to claim 1 wherein the comparison unit comprises one or both of the control device and a computing device.

5. A system according to claim 1 wherein the comparison unit comprises one or both of a computer and a mobile phone, and the comparison unit is configured to use web-based software via a web-browser.

6. A system according to claim 1, wherein the predefined settings are comprised in a program and the comparison unit is further configured to run the program to generate control parameters based on the predefined settings, the control parameters in turn being used to control the extracted set of electrical appliances.

7. A system according to claim 1, wherein the stored data in the database comprises a list of areas in a premise, each area being associated with each of the list of users and comprising the set of electrical appliances associated with the user.

8. system according to claim 1, wherein the control device is configured to control the extracted set of electrical appliances by one or more of the following: turning on or off at least one electrical appliance in the extracted set of electrical appliances, turning up or down at least one electrical appliance in the extracted set of electrical appliances, logging on or off at least one electrical appliance in the extracted set of electrical appliances and logging at least one electrical appliance in the extracted set of electrical appliances on or off a network or a database.

9. A system according to claim 1, wherein the control device is configured to turn off at least one electrical appliance in the extracted set of electrical appliances.

10. An integrated system comprising:
a lock device for regulating access to a secure area; and
a system for controlling electrical appliances in the secure area according to any of the preceding claims;
wherein the control device is further configured to control the lock device based on the comparison between the acquired detection data and the stored detection data in the database, and upon unlocking of the lock device to control the respective set of electrical appliances associated with an identified user.

11. An integrated system according to claim 10, wherein the at least one detection device comprises a first set of detection devices and a second set of detection devices, and wherein the comparison unit is further configured to determine from which set of detection devices the acquired detection data is received and the control device is further configured to control the extracted set of electrical appliances based on this determination.

12. A method for controlling electrical appliances, the method comprising:
acquiring detection data, indicating the presence or absence of a user in a spatial region;
accessing a database storing data associating each of a list of users with respective stored detection data and a respective set of electrical appliances;
comparing the acquired detection data against the stored detection data in the database;
if the acquired detection data matches the stored detection data of one of the list of users in the database, identifying the user associated with the matched stored detection data and extracting the set of electrical appliances associated with the identified user; and
controlling the extracted set of electrical appliances associated with the identified user based on predefined settings;
wherein the set of electrical appliances associated with the identified user comprises a plurality of electrical appliances.
